(19) United States
(12) Patent Application Publication
(10) Pub. No.: US 2019/0311428 A1
(43) Pub. Date: Oct. 10, 2019

(54) CREDIT RISK AND DEFAULT PREDICTION BY SMART AGENTS

(71) Applicant: Brighterion, Inc., San Francisco, CA (US)

(72) Inventor: Akli Adjaoute, Mill Valley, CA (US)

(21) Appl. No.: 15/947,790

(22) Filed: Apr. 7, 2018

(51) Int. Cl. G06Q 40/02; G06K 9/62; G06F 15/18

(52) U.S. Cl. CPC G06Q 40/025; G06F 15/18; G06K 9/6256

(57) ABSTRACT

Provided are artificial-intelligence based, electronic computer implemented processes and systems of analyzing credit risk and/or predicting default to an institution by an entity having been issued a plurality of credentials by individuals of the entity. The processes and systems involve: providing a smart agent for each credential; updating each smart agent with data of its credential so that so that each smart agent models an individual behavior profile; computing timely fields for the entity on spent using the credentials, amounts paid to the institution, and amounts due to the institution, thereby providing an timely assessment of overall entity demographic and financial situation; using the assessment to assign to the entity a risk level of delinquency; and predicting a likelihood of upcoming delinquency or default by the entity to the institution based on the individual behavior profiles modeled by the smart agents and on the risk level.

### BACKGROUND OF THE INVENTION

### Field of the Invention

The present invention generally relates to credit-risk and/or default predictions, and more particularly to electronic processes and systems that use artificial intelligence and/or smart-agent based techniques to help institutions assess, forecast and/or avoid risks/pitfalls of default by entities doing business therewith, typically in an electronic manner.

### Background Art

Artificial Intelligence (AI) will soon be at the heart of every major technological system in the world including: cyber and homeland security, payments, financial markets, biotech, healthcare, marketing, natural language processing, computer vision, electrical grids, nuclear power plants, air traffic control, and Internet of Things (IoT).

While AI seems to have only recently captured the attention of humanity, the reality is that AI has generally been around for over 60 years as a technological discipline. In the late 1950's, Arthur Samuel wrote a checkers playing program that could learn from its mistakes and thus, over time, became better at playing the game. MYCIN, the first rule-based expert system, was developed in the early 1970's and was capable of diagnosing blood infections based on the results of various medical tests. The MYCIN system was able to perform better than non-specialist doctors. Thus, in a general sense, while AI may be used to mimic what best humans minds can accomplish, it is not a patent ineligible mental process as some have contended.

Electronic and computer systems have been used in to effect financial data processing. There are a number of issued patents that relate to lender credit scoring, lender profiling, lender behavior analysis and modeling. In addition, the following issued patents have turned up in a search for art that may or may not be relevant to the technologies claimed below: U.S. Pat. Nos. 9,898,779; 9,609,330; 9,426,494; 9,154,798; 8,831,087; 8,762,261; 8,566,565; 8,386,379; 8,180,703; 8,121,940; 8,078,530; 8,015,108; 8,010,472; 8,010,449; 7,881,027; 7,877,323; 7,844,544; 7,805,363; 7,197.570; 6,751,510; 5,966,737; 5,953,747. However, the disclosure contained therein is incorporated by reference herein so as to provide examples of technologies not necessarily covered by the claims set forth below under appropriate interpretation of 35 USC 102 and 103 and associated case law.

In any case, there are opportunities in the art to provide an improved system and process for assessing credit-risk and/or default predictions to an unprecedented manner/degree.

### SUMMARY OF THE INVENTION

In a first embodiment, an artificial-intelligence based, electronic computer implemented process is provided for analyzing credit risk and/or predicting default to an institution by an entity having been issued a plurality of credentials to or by individuals of the entity. Steps of the process may involve, for example,(a) providing a smart agent for each credential; (b) updating each smart agent with transaction based data of its credential so that so that each smart agent models an individual behavior profile; (c) computing timely fields for the entity on spent using the credentials, amounts paid by the entity to the institution, and amounts due to the institution during predetermined time periods, thereby providing an timely assessment of overall entity demographic and financial situation; (d) using the assessment to assign to the entity a risk level of delinquency; and (e) predicting a likelihood of upcoming delinquency or default by the entity to the institution based on the individual behavior profiles modeled by the smart agents and on the risk level of delinquency.

The credential may be a credit card, electronic or otherwise and/or a debit card. The credential may be associated with a loan or line of credit to the entity, e.g., a non-human legal entity.

At least one individuals is typically human. In general, individuals or entities of the invention have provided to the entity or to the institution sufficient information to generate an initial credit report or background check to provide initial training.

Typically, each smart agent initially models a template individual behavior profile. The template behavior profile may be based on assumptions from aggregate historical. The template individual behavior profile may be based on actual behavior of a real human individual.

The risk level of delinquency may be selected from no risk, low risk, medium risk, and high risk. No risk is associated with regular normal payments, low risk is associated with occasional payment delay, medium risk is associated with frequent payment delays, and high risk is associated with long payment delays.

The inventive process may further involve taking action to reduce of consequences default when the risk of delinquency is at least medium risk, such as: taking action to reduce a likelihood of default when this risk of delinquency is high; reducing a credit limit for the entity or at least one individual; seeking more timely payment to the institution; increasing an interest rate for a balance owed to the institution or assessing a penalty when the risk level increases; and/or decreasing an interest for a balance owed to the institution when the risk level decreases.

The invention may also involve assessing whether the entity is delinquent according to one of first, second or third types, wherein the first type is characterized as having no more than two delinquent periods in a observed time frame and each delinquent period is less than about 14 days; the third type is characterized as having a last delinquent period of a duration of at least about 50 days without any payment, and the second type is characterized as being delinquent in a manner different from the first and third types.

In another embodiment, an artificial-intelligence based, electronic system is provided for analyzing credit risk and/or predicting default to an institution by an entity having been issued a plurality of credentials to or by individuals of the entity, comprising at least one computer that includes both hardware and software components. Together, the hardware and software components form: a smart agent means for providing a smart agent for each credential; an updating means for updating each smart agent with transaction based data of its credential so that so that each smart agent models an individual behavior profile; an accounting means for computing timely fields for the entity on spent using the credentials, amounts paid by the entity to the institution, and amounts due to the institution during predetermined time periods, thereby providing an timely assessment of overall entity demographic and financial situation; a risk level assessment means that uses the assessment to assign to the entity a risk level of delinquency; and a predicting means for predicting a likelihood of upcoming delinquency or default by the entity to the institution based on the individual behavior profiles modeled by the smart agents and on the risk level of delinquency. The system may be a distributed system comprising a plurality of linked nodes.

Other and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1, (which may include FIGS. 1A, 1B, etc.), shows a diagram that depict a specific embodiment of the invention. As discussed below, the invention may include a production stage and a learning stage.

### DETAILED DESCRIPTION OF THE INVENTION

Definitions and Overview

Before describing the invention in detail, it is to be understood that the invention is not generally limited to specific electronic platforms or types of computing systems, as such may vary. It is also to be understood that the terminology used herein is intended to describe particular embodiments only, and is not intended to be limiting.

Furthermore, as used in this specification and the appended claims, the singular article forms “a,” “an,” and “the” include both singular and plural referents unless the context clearly dictates otherwise. Thus, for example, reference to “a smart agent” includes a plurality of smart agents as well as a single smart agent, reference to “an assessment” includes a single authorization limit as well as a collection of assessments, and the like.

In addition, the appended claims are to be interpreted as reciting subject matter that may take the form of a new and useful process machine, manufacture, and/or composition of matter, and/or any new and useful improvement thereof instead of an abstract idea.

When the invention takes the form of a method or process, the method or process may be described as a list of steps with leading identifiers such as, e.g., (a), (b), (c). . . . The order of identifiers, regardless whether the identifiers are numerical and/or alphabetical, may or may not indicate the order in which the steps are listed for infringement analysis purposes. That is, for infringement analysis purposes, the invention does not have to involve the steps being carried out in an alphabetical order. However, the claims must be interpreted in a manner that preserves validity of the claims whenever possible.

In this specification and in the claims that follow, reference is made to a number of terms that are defined to have the following meanings, unless the context in which they are employed clearly indicates otherwise:

The term “cryptocurrency” is used in its ordinary sense and refers to a digital currency in which encryption techniques are used to regulate the generation of units of currency and verify the transfer of funds, operating independently of a central bank. Bitcoin is an example of cryptocurrency.

The terms “delinquent,” “delinquency,” and the like are used in their economic sense and refers to failure in or neglect of duty or obligation; dereliction; something, as a debt, that is past due. In contrast, the term “default” is use to refer to failure to fulfill an obligation, e.g., to repay a loan or appear in a court of law. Thus, “default” and “delinquent” are not to be interpreted in a synonymous manner.

The terms “electronic,” “electronically,” and the like are used in their ordinary sense and relate to structures, e.g., semiconductor microstructures, that provide controlled conduction of electrons or other charge carriers, e.g., microstructures that allow for the controlled movement of holes in electron clouds.

The term “entity” is used herein in its ordinary sense and refer to a legal construct with distinct and independent existence, such as a human individual, a corporation, a partnership, etc.

The term “institution” is used herein in its ordinary sense and refer to a society

The term “internet” is used herein in its ordinary sense and refers to an interconnected system of networks that connects computers around the world via the TCP/IP and/or other protocols. Unless the context of its usage clearly indicates otherwise, the term “web” is generally used in a synonymous manner with the term “internet.”

The term “method” is used herein in a synonymous manner as the term “process” is used in 35 U.S.C. 101. Thus, both “methods” and “processes” described and claimed herein are patent eligible per 35 U.S.C. 101.

The term “node” is used generally in its telecommunication network sense, and refers either a redistribution point or a communication endpoint. The specific definition of a node depends on the network and protocol layer referred to. A network node may be physical or virtual in nature.

The term “smart agent” is used herein as a term of art to refer to specialized technology that differs from prior art technologies relating to bots or agents, e.g., used in searching information or used by social medial to keep track of birthday's systems or order pizzas. A “smart agent” described herein is an entity that is capable of having an effect on itself and its environment. It disposes of a partial representation of this environment. Its behavior is the outcome of its observations, knowledge and interactions with other smart-agents. The smart agent technology described herein, rather than being pre-programed to try to anticipate every possible scenario or relying on pre-trained models, tracks and adaptively learns the specific behavior of every entity of interest over time. Thus, continuous one-to-one electronic behavioral analysis provides real-time actionable insights and/or warnings. In addition, smart agent technology described herein engages in adaptive learning that continually updates models to provide new intelligence. Furthermore, the smart agent technology solves technical problems associated with massive databases and/or data processing. Experimental data show about a one-millisecond response on entry-level computer servers. Such a speed is not achievable with prior art technologies. Additional differences between the smart agent technology claimed and prior so-called “smart agent” technology will be apparent upon review of the disclosure contained herein.

The terms “substantial” and “substantially” are used in their ordinary sense and are the antithesis of terms such as “trivial” and “inconsequential.” For example, when the term “substantially” is used to refer to behavior that deviates from a reference normal behavior profile, the difference cannot constitute a mere trivial degree of deviation. The terms “substantial” and “substantially” are used analogously in other contexts involve an analogous definition.

Artificial Intelligence and Machine Learning

In order to describe the invention fully, it is helpful to provide a generalized information pertaining to various aspects of artificial intelligence. Some selection or all of these technique below may be used in combination to achieve an optimal result.

Machine learning is the science of getting computers to act without being explicitly programmed. Machine learning is applied in various fields such as computer vision, speech recognition, NLP, web search, biotech, risk management, cyber security, and many others. The machine learning paradigm can be viewed as “programming by example”. Two types of learning are commonly used: supervised and unsupervised. In supervised learning, a collection of labeled patterns is provided, and the learning process is measured by the quality of labeling a newly encountered pattern. The labeled patterns are used to learn the descriptions of classes which in turn are used to label a new pattern. In the case of unsupervised learning, the problem is to group a given collection of unlabeled patterns into meaningful categories.

Within supervised learning, there are two different types of labels: classification and regression. In classification learning, the goal is to categorize objects into fixed specific categories. Regression learning, on the other hand, tries to predict a real value. For instance, we may wish to predict changes in the price of a stock and both methods can be applied to derive insights. The classification method is used to determine if the stock price will rise or fall, and the regression method is used to predict how much the stock will increase or decrease.

Artificial intelligence may also take the form of a business rule management system (BRMS) that enables companies to easily define, deploy, monitor, and maintain new regulations, procedures, policies, market opportunities, and workflows. One of the main advantages of business rules is that they can be written by business analysts without the need of IT resources. Rules can be stored in a central repository and can be accessed across the enterprise. Rules can be specific to a context, a geographic region, a customer, or a process. Advanced Business Rules Management systems offer role-based management authority, testing, simulation, and reporting to ensure that rules are updated and deployed accurately.

A neural network (NN) is a technology loosely inspired by the structure of the brain. A neural network consists of many simple elements called artificial neurons, each producing a sequence of activations. The elements used in a neural network are far simpler than biological neurons. The number of elements and their interconnections are orders of magnitude fewer than the number of neurons and synapses in the human brain.

Backpropagation (BP) is the most popular supervised neural network learning algorithm. Backpropagation is organized into layers and connections between the layers. The leftmost layer is called the input layer. The rightmost, or output, layer contains the output neurons. Finally, the middle layers are called hidden layers. The goal of backpropagation is to compute the gradient (a vector of partial derivatives) of an objective function with respect to the neural network parameters. Input neurons activate through sensors perceiving the environment and other neurons activate through weighted connections from previously active neurons. Each element receives numeric inputs and transforms this input data by calculating a weighted sum over the inputs. A non-linear function is then applied to this transformation to calculate an intermediate state. While the design of the input and output layers of a neural network is straightforward, there is an art to the design of the hidden layers. Designing and training a neural network requires choosing the number and types of nodes, layers, learning rates, training data, and test sets.

Deep learning, a new term that describes a set of algorithms that use a neural network as an underlying architecture, has generated many headlines. The earliest deep learning-like algorithms possessed multiple layers of non-linear features. They used thin but deep models with polynomial activation functions which they analyzed using statistical methods. Deep learning became more usable in recent years due to the availability of inexpensive parallel hardware (GPUs, computer clusters) and massive amounts of data. Deep neural networks learn hierarchical layers of representation from the input to perform pattern recognition. When the problem exhibits non-linear properties, deep networks are computationally more attractive than classical neural networks. A deep network can be viewed as a program in which the functions computed by the lower-layered neurons are subroutines. These subroutines are reused many times in the computation of the final program.

Deep learning requires human expertise and significant time to design and train. Care must be taken to ensure that changes are made in a manner that do not induce unacceptable errors that would offend the entity or an individual thereof.

Data mining, or knowledge discovery in databases, is the nontrivial extraction of implicit, previously unknown and potentially useful information from data. Statistical methods are used that enable trends and other relationships to be identified in large databases.

The major reason that data mining has attracted attention is due to the wide availability of vast amounts of data, and the need for turning such data into useful information and knowledge. The knowledge gained can be used for applications ranging from risk monitoring, business management, production control, market analysis, engineering, and science exploration.

In general, three types of data mining techniques are used: association, regression, and classification.

Association analysis is the discovery of association rules showing attribute-value conditions that occur frequently together in a given set of data. Association analysis is widely used to identify the correlation of individual products within shopping carts.

Regression analysis creates models that explain dependent variables through the analysis of independent variables. As an example, the prediction for a product's sales performance can be created by correlating the product price and the average customer income level.

Classification is the process of designing a set of models to predict the class of objects whose class label is unknown. The derived model may be represented in various forms, such as if-then rules, decision trees, or mathematical formulas.

A decision tree is a flow-chart-like tree structure where each node denotes a test on an attribute value, each branch represents an outcome of the test, and each tree leaf represents a class or class distribution. Decision trees can be converted to classification rules.

Classification can be used for predicting the class label of data objects. Prediction encompasses the identification of distribution trends based on the available data.

Data mining process consists essentially of an iterative sequence of the following steps: (1) Data coherence and cleaning to remove noise and inconsistent data; (2) Data integration such that multiple data sources may be combined; (3) Data selection where data relevant to the analysis are retrieved; (4) Data transformation where data are consolidated into forms appropriate for mining; (5) Pattern recognition and statistical techniques are applied to extract patterns; (6) Pattern evaluation to identify interesting patterns representing knowledge; (7)Visualization techniques are used to present mined knowledge to users.

For optimal results, data mining must make sure that GIGO (garbage in garbage out) is avoided, as the quality of the knowledge gained through data mining is dependent on the quality of the historical data. We know data inconsistencies and dealing with multiple data sources represent large problems in data management. Data cleaning techniques exist to deal with detecting and removing errors and inconsistencies from data to improve data quality. However, detecting these inconsistencies is extremely difficult. One question raised, then, is how one can identify a transaction that is incorrectly labeled as suspicious. Learning from incorrect data leads to inaccurate models.

Case-based reasoning (CBR) is a problem solving paradigm that is different from other major AI approaches. CBR learns from past experiences to solve new problems. Rather than relying on a domain expert to write the rules or make associations along generalized relationships between problem descriptors and conclusions, a CBR system learns from previous experience in the same way a physician learns from his patients. A CBR system will create generic cases based on the diagnosis and treatment of previous patients to determine the disease and treatment for a new patient. The implementation of a CBR system consists of identifying relevant case features. A CBR system continually learns from each new situation. Generalized cases can provide explanations that are richer than explanations generated by chains of rules.

The most important limitations relate to how cases are efficiently represented, how indexes are created, and how individual cases are generalized.

Traditional logic typically categorizes information into binary patterns such as, black/white, yes/no, or true/false. Fuzzy logic brings a middle ground where statements can be partially true and partially false to account for much of day-to-day human reasoning. For example, stating that a tall person is over 6′2″, traditionally means that people under 6′2″ are not tall. If a person is nearly 6′2″, then common sense says the person is also somewhat tall. Boolean logic states a person is either tall or short and allows no middle ground, while fuzzy logic allows different interpretations for varying degrees of height.

Neural networks, data mining, CBR, and business rules can benefit from fuzzy logic. For example, fuzzy logic can be used in CBR to automatically cluster information into categories which improve performance by decreasing sensitivity to noise and outliers. Fuzzy logic also allows business rule experts to write more powerful rules.

Genetic algorithms work by simulating the logic of Darwinian selection where only the best performers are selected for reproduction. Over many generations, natural populations evolve according to the principles of natural selection. A genetic algorithm can be thought of as a population of individuals represented by chromosomes. In computing terms, a genetic algorithm implements the model of computation by having arrays of bits or characters (binary string) to represent the chromosomes. Each string represents a potential solution. The genetic algorithm then manipulates the most promising chromosomes searching for improved solutions. A genetic algorithm operates through a cycle of three stages: (1) Build and maintain a population of solutions to a problem; (2) Choose the better solutions for recombination with each other; and (3) Use their offspring to replace poorer solutions.

Genetic algorithms provide various benefits to existing machine learning technologies such as being able to be used by data mining for the field/attribute selection, and can be combined with neural networks to determine optimal weights and architecture.

Problems Overcome by Invention

Researchers have explored many different architectures for intelligent systems: neural networks, genetic algorithms, business rules, Bayesian network, and data mining, to name a few. We will begin by listing the most important limits of legacy machine learning techniques and will then describe how the next generation of artificial intelligence based on smart-agents overcomes these limitations.

As mentioned earlier, current AI and machine learning technologies suffer from various limits. Most importantly, they lack the capacity for personalization, adaptability, and self-learning. With respect to personalization, to successfully protect and serve customers, employees, and audiences we must know them by their unique and individual behavior over time and not by static, generic categorization. With respect to adaptability, relying on models based only on historical data or expert rules are inefficient as new trends and behaviors arise daily. And with respect to self-learning, an intelligent system should learn overtime from every activity associated to each specific entity.

To further illustrate the limits of prior art technologies, we will use the challenges of two important business fields: network security and fraud prevention. Fraud and intrusion are perpetually changing and never remain static. Fraudsters and hackers are criminals who continuously adjust and adapt their techniques. Controlling fraud and intrusion within a network environment requires a dynamic and continuously evolving process. Therefore, a static set of rules or a machine learning model developed by learning from historical data have only short-term value.

Tools that autonomously detect new attacks against specific targets, networks or individual computers are needed. It must be able to change its parameters to thrive in new environments, learn from each individual activity, respond to various situations in different ways, and track and adapt to the specific situation/behavior of every entity of interest over time. This continuous, one-to-one behavioral analysis, provides real-time actionable insights. In addition to the self-learning capability, another key concept for the next generation of AI and ML systems is being reflective. Imagine a plumbing system that autonomously notifies the plumber when it finds water dripping out of a hole in a pipe and detects incipient leaks.

Smart Agent Technology

Smart agent technology claimed below is the only technology that has the ability to overcome the limits of the legacy machine learning technologies allowing personalization, adaptability and self-learning.

Smart agent technology is a personalization technology that creates a virtual representation of every entity and learns/builds a profile from the entity's actions and activities. In the payment industry, for example, a smart agent is associated with each individual cardholder, merchant, or terminal. The smart agents associated to an entity (such as a card or merchant) learns in real-time from every transaction made and builds their specific and unique behaviors overtime. There are as many smart agents as active entities in the system. For example, if there are 200 million cards transacting, there will be 200 million smart agents instantiated to analyze and learn the behavior of each. Decision-making is thus specific to each cardholder and no longer relies on logic that is universally applied to all cardholders, regardless of their individual characteristics. The smart agents are self-learning and adaptive since they continuously update their individual profiles from each activity and action performed by the entity.

Here are some examples to highlight how the smart agent technology differs from legacy machine learning technologies.

In an email filtering system, smart agents learn to prioritize, delete, forward, and email messages on behalf of a user. They work by analyzing the actions taken by the user and by learning from each. Smart agents constantly make internal predictions about the actions a user will take on an email. If these predictions prove incorrect, the smart agents update their behavior accordingly.

In a financial portfolio management system, a multi-agent system consist of smart agents that cooperatively monitor and track stock quotes, financial news, and company earnings reports to continuously monitor and make suggestions to the portfolio manager.

Smart agents do not rely on pre-programmed rules and do not try to anticipate every possible scenario. Instead, smart agents create profiles specific to each entity and behave according to their goals, observations, and the knowledge that they continuously acquire through their interactions with other smart agents. Each Smart agent pulls all relevant data across multiple channels, irrespectively to the type or format and source of the data, to produce robust virtual profiles. Each profile is automatically updated in real-time and the resulting intelligence is shared across the smart agents. This one-to-one behavioral profiling provides unprecedented, omni-channel visibility into the behavior of an entity.

Smart agents can represent any entity and enable best-in-class performance with minimal operational and capital resource requirements. Smart agents automatically validate the coherence of the data, perform the features learning, data enrichment as well as one-to-one profiles creation. Since they focus on updating the profile based on the actions and activities of the entity, they store only the relevant information and intelligence rather than storing the raw incoming data they are analyzing, which achieves enormous compression in storage.

Legacy technologies in machine learning generally relies on databases. A database uses tables to store structured data. Tables cannot store knowledge or behaviors. Artificial intelligence and machine learning systems requires storing knowledge and behaviors. Smart agents bring a powerful, distributed file system specifically designed to store knowledge and behaviors. This distributed architecture allows lightning speed response times (below 1 millisecond) on entry level servers as well as end-to-end encryption and traceability. The distributed architecture allows for unlimited scalability and resilience to disruption as it has no single point of failure.

The following are some examples which highlight how the smart agent technology differs from legacy machine learning technologies.

In an email filtering system, smart agents learn to prioritize, delete, forward, and email messages on behalf of a user. They work by analyzing the actions taken by the user and by learning from each. Smart agents constantly make internal predictions about the actions a user will take on an email. If these predictions prove incorrect, the smart agents update their behavior accordingly.

In a financial portfolio management system, a multi-agent system may consist essentially of smart agents that cooperatively monitor and track stock quotes, financial news, and company earnings reports to continuously monitor and make suggestions to the portfolio manager.

Smart agents do not rely on pre-programmed rules and do not try to anticipate every possible scenario. Instead, smart agents create profiles specific to each entity and behave according to their goals, observations, and the knowledge that they continuously acquire through their interactions with other smart agents. Each Smart agent pulls all relevant data across multiple channels, irrespectively to the type or format and source of the data, to produce robust virtual profiles. Each profile is automatically updated in real-time and the resulting intelligence is shared across the smart agents. This one-to-one behavioral profiling provides unprecedented, omni-channel visibility into the behavior of an entity.

Smart agents can represent any entity and enable best-in-class performance with minimal operational and capital resource requirements. Smart agents automatically validate the coherence of the data, perform the features learning, data enrichment as well as one-to-one profiles creation. Since they focus on updating the profile based on the actions and activities of the entity, they store only the relevant information and intelligence rather than storing the raw incoming data they are analyzing, which achieves enormous compression in storage.

Legacy technologies in machine learning generally relies on databases. A database uses tables to store structured data. Tables cannot store knowledge or behaviors. Artificial intelligence and machine learning systems requires storing knowledge and behaviors. Smart agent technologies bring a powerful, distributed file system specifically designed to store knowledge and behaviors. This distributed architecture allows lightning speed response times (below about one millisecond) on entry level servers as well as end-to-end encryption and traceability. The distributed architecture allows for unlimited scalability and resilience to disruption as it has no single point of failure.

Exemplary Embodiment of the Invention

An exemplary embodiment of the invention involves an electronic system that may help an entity and its business partner institution avoid default by treating individuals differently according to established behavior of such individuals through the use of smart agents, artificial intelligence and machine learning.

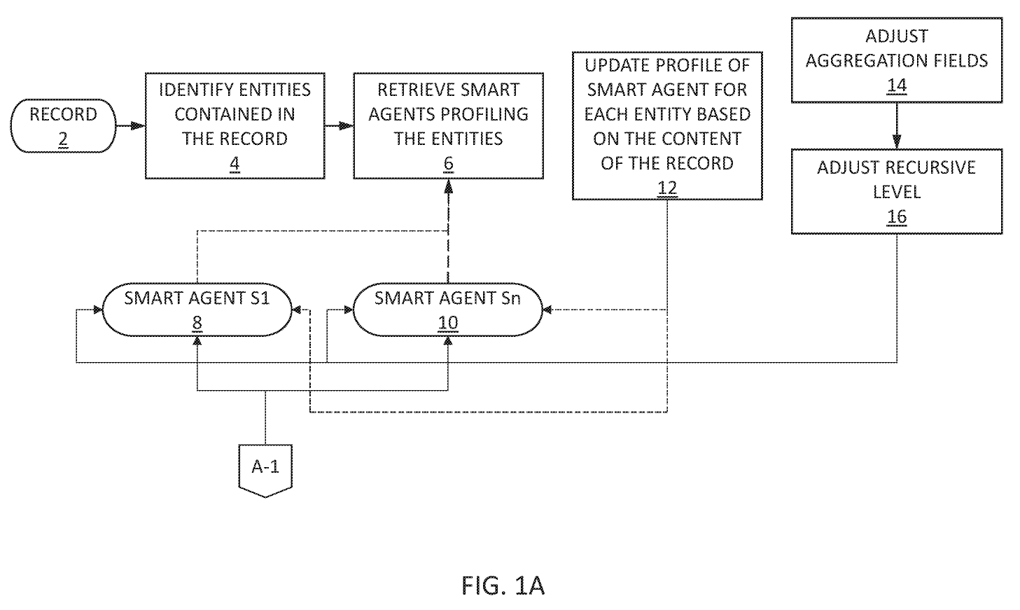

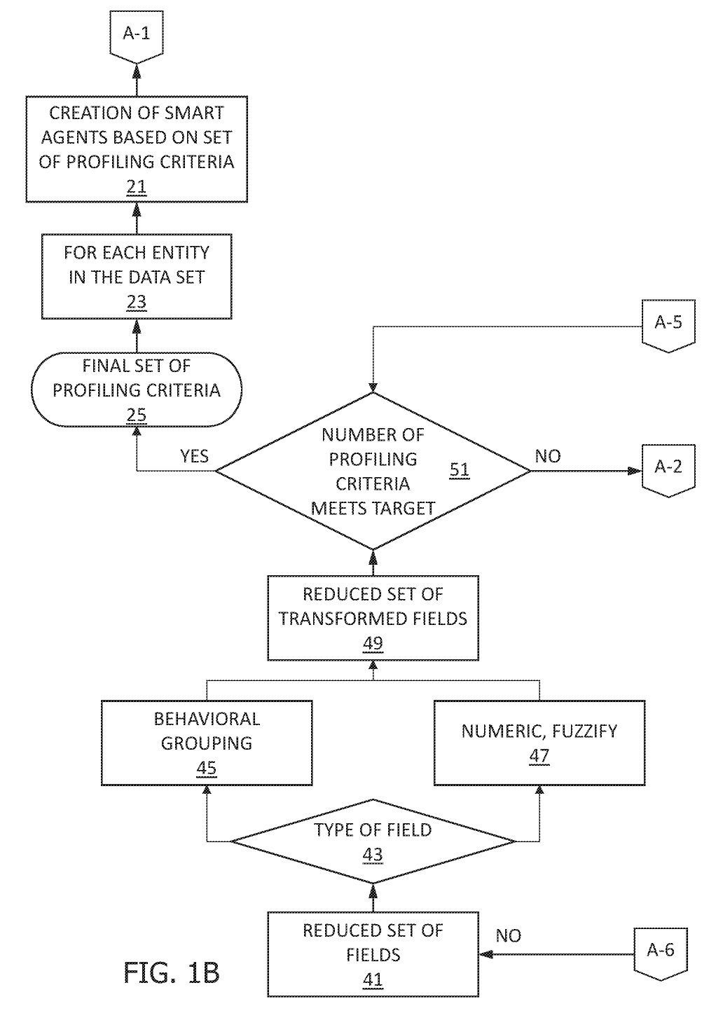

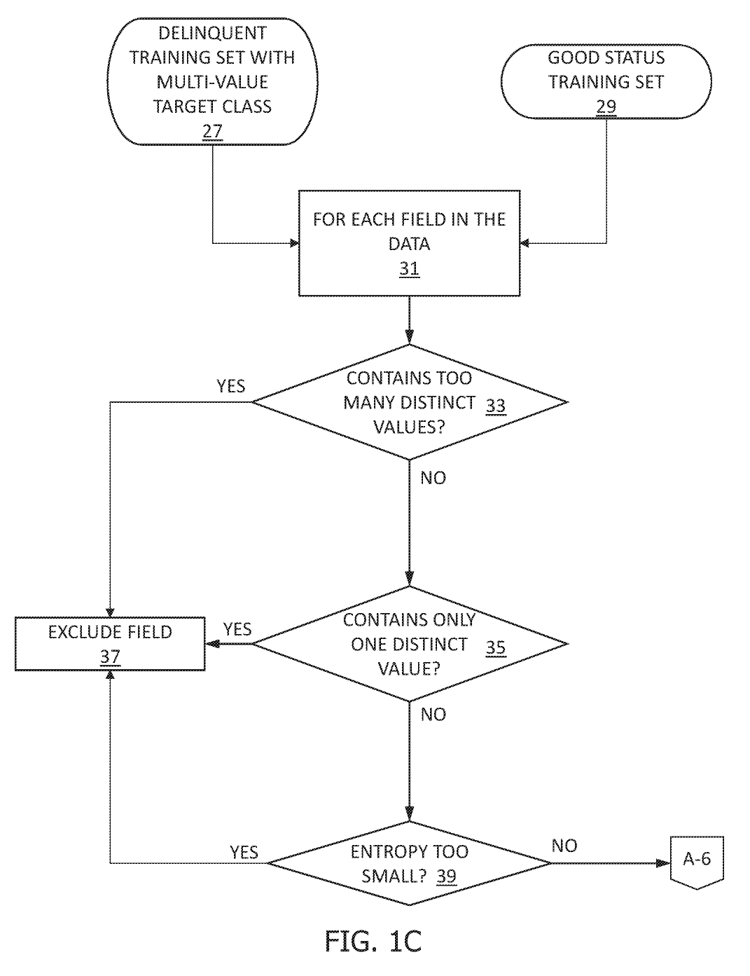

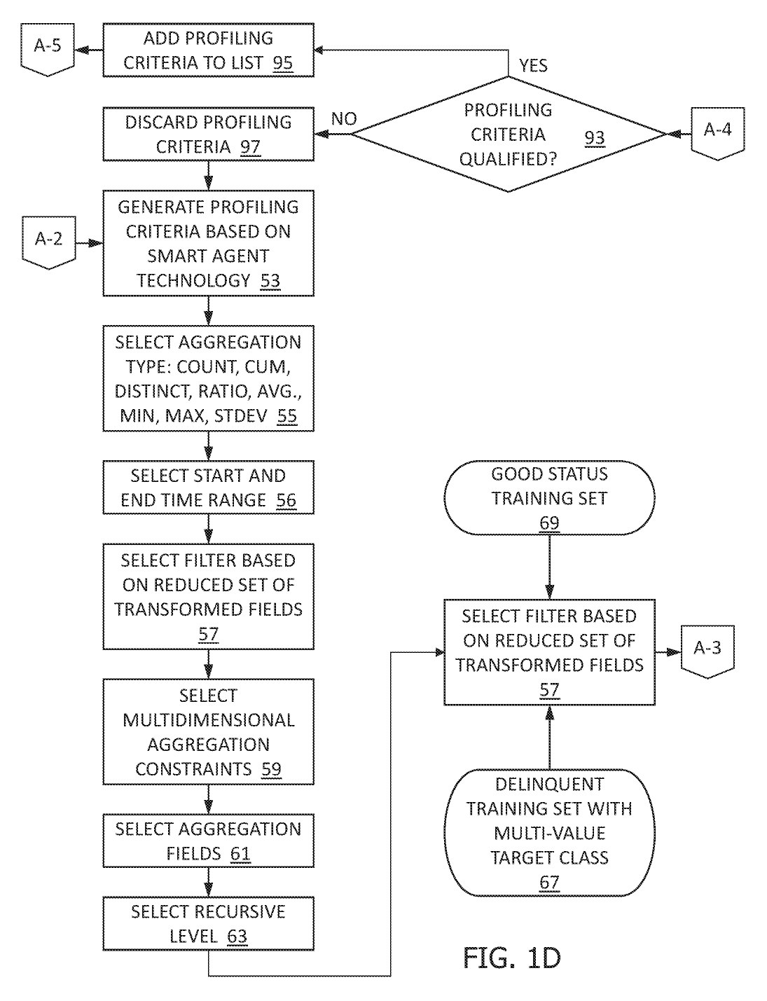

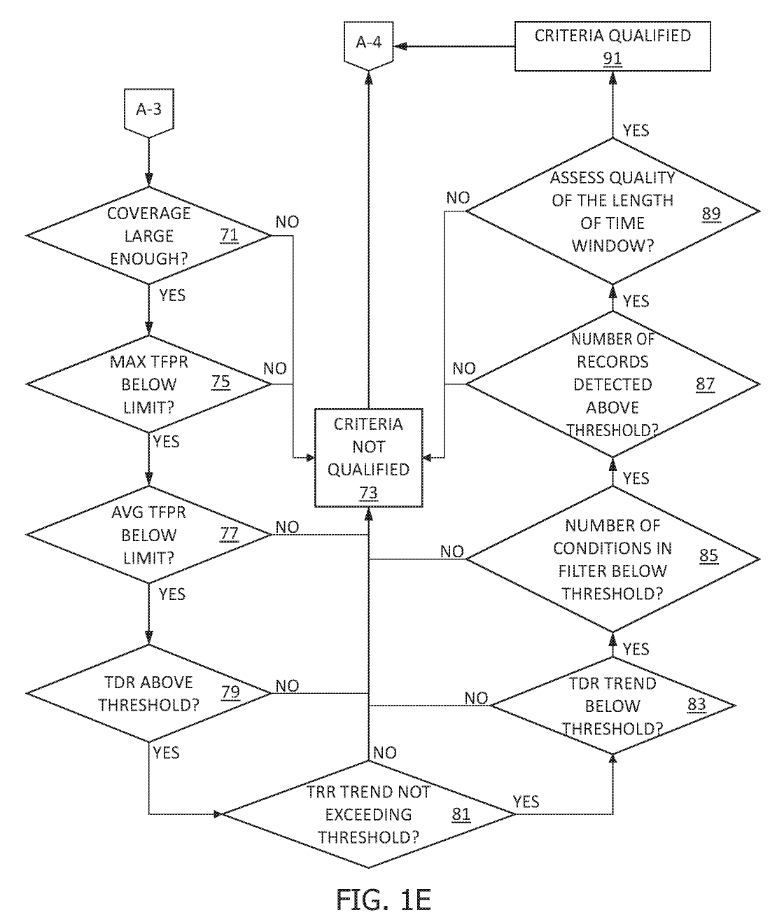

FIG. 1 depicts an embodiment of the invention. Persons of ordinary skill in the art should be able to write, test, and implement software programs in appropriate electronic hardware to effect the functionality set forth in FIG. 1. As shown, the invention may, in part, take place in production stage wherein real-time actions take place. In addition or in the alternative, the invention may, in part take place in, learning stage, wherein the invention allows for the design and training of models supporting the smart-agent-based technology of the invention.

The following references numbers identify matter, e.g., action, conditions, found in the flow chart/diagram of FIG. 1.

Production Stage

In production stage, as depicted in FIG. 1, the following reference numbers refer to like functionality, conditions, etc. The relationship between the referenced functionality, conditions, etc., are set forth in solid, dashed, and/or bolded lines (optionally with arrows).

2—Record

4—Identify entities contained in the record

6—Retrieve the smart agents profiling the entities

8—Smart agent S1

10—Smart agent Sn

12—Update the profile of the smart agents for each entities based on the content of the record

14—Adjust aggregation fields (if needed)

16—Adjust recursive level

Learning Stage

In learning stage, as depicted in FIG. 1, the following reference numbers refer to like functionality, conditions, etc. The relationship between the referenced functionality, conditions, etc., are set forth in solid, dashed, and/or bolded lines (e.g., with arrows).

21—Creation of the smart agents based on the set of profiling criteria.

23—For each entity in the data set

25—Yes. Final set of profiling criteria

27—Delinquent training set with multivalue target class

29—Good status training set

31—For each field in the data

33—Contains only too many distinct values

35—No, Contains only one single value

37—Yes, Yes, Yes, Exclude field

39—No, Entropy too small

41—No, Reduced set of fields

43—Type of field

45—Symbolic, Behavioral grouping

47—Numeric, Fuzzify

49—Reduced set of transformed fields

51—Number of profiling criterial meets target

53—No, Generate profiling criteria based on smart agent profiling technology

55—Select aggregation type: count, sum, distinct, ratio, avg, min, max, stdev, . . .

57—Select filter based on reduced set of transformed fields

59—Select multi-dimensional aggregation constraints

61—Select aggregation fields (if needed)

63—Select recursive level

65—Access profiling criteria quality

67—Delinquent training set with multi value target class

69—Good Status training set

71—Is coverage large enough?

73—No, No, No, No, No, No, No, No, Below threshold, Criteria not qualified

75—Yes, Is Max TFPR below limit?

77—Yes, Is Average TFPR below limit?

79—Yes, Is TDR above threshold?

81—Yes, Trend of TRR over time is not exceeding threshold?

83—Yes, Trend of TDR over time is below threshold?

85—Yes, Number of conditions in the filter is below threshold?

87—Yes, Number of records detected above threshold?

89—Yes, Assess quality of the length of time window.

91—Criteria Qualified

93—Is profiling criteria qualified?

95—Yes, Add profiling criterial to the list

97—No, Discard profiling criteria

Additional actions, conditions, etc., may be added or deleted depending on need or other circumstances. Thus, all 35 USC 112 requirements are satisfied with the claims set forth below.

Variations of the present invention will be apparent to those of ordinary skill in the art in view of the disclosure contained herein. For example, specialized tools and modules, e.g., in the form of software, computer programs, or circuitry, may be developed to allow programmers and administrators to set up systems and processes or methods in accordance with the invention.

In any case, it should be noted that any particular embodiment of the invention may be modified to include or exclude features of other embodiments as appropriate without departing from the spirit of the invention. It is also believed that principles such as “economies of scale” and “network effects” are applicable to the invention and that synergies arising from the invention's novelty and nonobviousness increase when the invention is practiced with increasing numbers of individuals, entities, users, and/or institutions. Appropriate usage of computerized and/or communication means, e.g., web-based hardware and/or software, cellular and land-based telephonic equipment, and antenna-based, satellite and coaxial and/or ethernet cable/wire technologies, allow for further synergies, thereby rendering the invention more nonobvious that that described in the printed references that do not disclose the above-identified computerized and/or communication means..

It is to be understood that, while the invention has been described in conjunction with the preferred specific embodiments thereof, the foregoing description merely illustrates and does not limit the scope of the invention. Numerous alternatives and equivalents exist which do not depart from the invention set forth above. Other aspects, advantages, and modifications within the scope of the invention will be apparent to those skilled in the art to which the invention pertains.

All patents and publications mentioned herein are hereby incorporated by reference in their entireties to the fullest extent not inconsistent with the description of the invention set forth above.

What is claimed is:

1. An artificial-intelligence based, electronic computer implemented process of analyzing credit risk and/or predicting default to an institution by an entity having been issued a plurality of credentials to or by individuals of the entity, comprising the steps of:
(a) providing a smart agent for each credential;
(b) updating each smart agent with transaction based data of its credential so that so that each smart agent models an individual behavior profile;
(c) computing timely fields for the entity on spent using the credentials, amounts paid by the entity to the institution, and amounts due to the institution during predetermined time periods, thereby providing an timely assessment of overall entity demographic and financial situation;
(d) using the assessment to assign to the entity a risk level of delinquency; and
(e) predicting a likelihood of upcoming delinquency or default by the entity to the institution based on the individual behavior profiles modeled by the smart agents and on the risk level of delinquency.

2. The process of claim 1, wherein the credential is a credit card.

3. The process of claim 1, wherein the credential is a debit card.

4. The process of claim 1, wherein the credential is associated with a loan or line of credit to the entity.

5. The process of claim 1, wherein the entity is a non-human legal entity.

6. The process of claim 1, wherein at least one of the individuals is human.

7. The process of claim 1, wherein at least one individual has provided to the entity or to the institution sufficient information to generate an initial credit report or background check to provide initial training to the smart agent associated with the at least one individual.

8. The process of claim 1, wherein, before step (b), the smart agent initially models a template individual behavior profile.

9. The process of claim 8, wherein the template behavior profile is based on assumptions from aggregate historical.

10. The process of claim 8, wherein the template individual behavior profile is based on actual behavior of a real human individual.

11. The process of claim 1, wherein the risk level of delinquency is selected from no risk, low risk, medium risk, and high risk, such that
no risk is associated with regular normal payments,
low risk is associated with occasional payment delay,
medium risk is associated with frequent payment delays, and
high risk is associated with long payment delays.

12. The process of claim 11, further comprising:
(f) taking action to reduce of consequences default when the risk of delinquency is at least medium risk.

13. The process of claim 12, wherein (f) involves taking action to reduce a likelihood of default when this risk of delinquency is high.

14. The process of claim 12, wherein (f) comprises reducing a credit limit for the entity or at least one individual.

15. The process of claim 12, wherein (f) comprises seeking more timely payment to the institution.

16. The process of claim 11, further comprising:
(f) increasing an interest rate for a balance owed to the institution or assessing a penalty when the risk level increases.

17. The process of claim 11, further comprising:
(f) decreasing an interest for a balance owed to the institution when the risk level decreases.

18. The process of claim 11, wherein step (c) involves assessing whether the entity is delinquent according to one of first, second or third types, wherein
the first type is characterized as having no more than two delinquent periods in a observed time frame and each delinquent period is less than 14 days,
the third type is characterized as having a last delinquent period of a duration of at least 50 days without any payment, and
the second type is characterized as being delinquent in a manner different from the first and third types.

19. An artificial-intelligence based, electronic system for analyzing credit risk and/or predicting default to an institution by an entity having been issued a plurality of credentials to or by individuals of the entity, comprising at least one computer that includes both hardware and software components, that together or individually form:
a smart agent means for providing a smart agent for each credential;
an updating means for updating each smart agent with transaction based data of its credential so that so that each smart agent models an individual behavior profile;
an accounting means for computing timely fields for the entity on spent using the credentials, amounts paid by the entity to the institution, and amounts due to the institution during predetermined time periods, thereby providing an timely assessment of overall entity demographic and financial situation;
a risk level assessment means that uses the assessment to assign to the entity a risk level of delinquency; and
a predicting means for predicting a likelihood of upcoming delinquency or default by the entity to the institution based on the individual behavior profiles modeled by the smart agents and on the risk level of delinquency.

20. The system of claim 19, being a distributed system comprising a plurality of linked nodes.
